(19) United States
(12) Patent Application Publication
(10) Pub. No.: US 2026/0077461 A1
(43) Pub. Date: Mar. 19, 2026

(54) VALVE CORE REMOVAL TOOL

(71) Applicant: DE ZHANG, RUI'AN (CN)

(72) Inventors: DE ZHANG, RUI'AN (CN); HONGWEI WANG, RUI'AN (CN)

(21) Appl. No.: 18/985,431

(22) Filed: Dec. 18, 2024

(30) Foreign Application Priority Data
Sep. 14, 2024 (CN) 202422259592.0

(51) Int. Cl. B25B 27/24

(52) U.S. Cl. CPC B25B 27/24

(57) ABSTRACT

Disclosed is a valve core removal tool, including a sleeve with a bottom opening; an inner cylinder with a bottom opening sleeved inside the sleeve, moving along an axial direction of the sleeve; locking portions, provided on both sides of the inner cylinder and moving along a radial direction of the inner cylinder; and a screw rod, axially arranged on the inner cylinder, with one end connected to the inner cylinder and the other end extending out of the sleeve, where a fixing portion is provided at the bottom opening of the sleeve, the inner cylinder is moved above the fixing portion, the locking portions move inward for locking, the screw rod rises along the sleeve, and the inner cylinder moves upward along the axial direction of the sleeve away from a bottom of the sleeve based on the movement of the screw rod.

### TECHNICAL FIELD

The present disclosure relates to the technical field of removal tools, and in particular to a valve core removal tool.

### BACKGROUND

For valve cores that are faulty or have corroded over time in valve bodies, it is necessary to promptly remove the valve cores from the valve bodies. Due to the narrow space between the valve body and the valve core, it may be difficult to remove the valve core or impossible to complete disassembly and maintenance operations during replacement.

At present, a head of a valve core is mainly gripped by a hand or clamped by a tool such as pliers, and taken out by pulling with manpower or tapping with an external force. It is inconvenient to take out the valve core directly by the hand, and it is easy to cause damage to the hand. It is also troublesome to remove the valve core with the help of tools such as pliers, because the valve core is made of a plastic material, if the force is not well controlled, the valve core will be prone to breaking and getting stuck inside a valve body. It often takes too long to extract the valve core, which affects production and increases labor intensity of workers.

It can be seen that the above-mentioned existing methods of extracting valve cores that are faulty or have corroded over time in valve bodies still have inconveniences and defects, and need to be further improved. How to create a new valve core removal tool so that it can easily remove the valve core from the valve body has become a goal that urgently needs improvement in the current industry.

### SUMMARY

The technical problem to be solved by the present disclosure is to provide a valve core removal tool so that it can easily take out a valve core from a valve body, thereby overcoming the problem that the valve core is broken and stuck in the valve body by pulling with manpower or tapping with an external force.

In order to solve the above problem, the present disclosure provides a valve core removal tool, which includes: a sleeve with a bottom opening;

an inner cylinder with a bottom opening sleeved inside the sleeve, moving along an axial direction of the sleeve;

locking portions, provided on both sides of the inner cylinder and moving along a radial direction of the inner cylinder; and

a screw rod, axially arranged on the inner cylinder, with one end connected to the inner cylinder and the other end extending out of the sleeve; where

a fixing portion is provided at the bottom opening of the sleeve, the inner cylinder is moved above the fixing portion, the locking portions move inward for locking, the screw rod rises along the sleeve, and the inner cylinder moves upward along the axial direction of the sleeve away from a bottom of the sleeve based on the movement of the screw rod.

As an improvement of the present disclosure, sliding grooves are provided on both sides of the sleeve, the locking portions extend out of the sleeve through the sliding grooves, and the locking portions slide in the sliding grooves with the movement of the inner cylinder.

As an improvement of the present disclosure, the locking portions include:

jack screw holders arranged on both sides of the inner cylinder, jack screws matched with the jack screw holders, and a handle mounted on one end of each of the jack screws;

the jack screw holders are provided with through holes with internal threads, and the through holes are communicated with the inner cylinder; and by rotating the jack screws with the handles, the jack screws move inward through the through holes for locking and fixing.

As an improvement of the present disclosure, a tapered spike structure is provided on a head of each of the jack screws.

As an improvement of the present disclosure, a first clamp ring is arranged outside a top of the inner cylinder, and the screw rod is rotatably fixed on the inner cylinder by the first clamp ring.

As an improvement of the present disclosure, the present disclosure further includes a rotary cap fitted to a top of the sleeve, and a shaft sleeve is arranged at a bottom center of the rotary cap in a protruding manner;

a mounting hole is reserved in a top center of the sleeve, and the shaft sleeve extends into the sleeve through the mounting hole;

a second clamp ring is arranged inside the top of the sleeve, and is clamped with the shaft sleeve; and the rotary cap is rotatably fixed on the sleeve by the shaft sleeve and the second clamp ring.

As an improvement of the present disclosure, the shaft sleeve is internally provided with a threaded structure, the screw rod is connected to the shaft sleeve in cooperation, the rotary cap rotates on the top of the sleeve to drive the screw rod to move upward, and the inner cylinder is driven by the screw rod to slide upward.

As an improvement of the present disclosure, a thrust bearing is mounted on the top of the sleeve, a groove is formed in a bottom of the rotary cap, and the groove is in nested fit with the thrust bearing.

As an improvement of the present disclosure, the fixing portion has an internal thread structure; and/or

the first clamp ring and the second clamp ring are designed as E-shaped clamp rings.

As an improvement of the present disclosure, a screw cap is arranged at the end of the screw rod extending out of the sleeve.

With such a design, the present disclosure has at least the following advantages:

1. When in use of the valve core removal tool, the inner cylinder slidable up and down is arranged inside the sleeve, the valve core is fixed by the locking portions provided on both sides of the inner cylinder, the screw is arranged on the top of the inner cylinder, the bottom of the sleeve is fixed with the valve body, the screw rod rises and drives the inner cylinder to move upward, and the valve core is easily pulled out of the valve body. The faulty valve core can be easily removed without requiring any additional tools in the removing process.

2. The locking portions are provided with the jack screws, and tips of the jack screws are enabled to pierce into a plastic case outside the valve core for fastening, so that the valve core is prevented from being broken and stuck inside the valve body.

3. The rotary cap is arranged on the top of the sleeve, the screw rod is in screw thread fit with the rotary cap, and the screw rod is driven to rise by screwing the rotary cap, so as to lift the inner cylinder fixing the valve core; and therefore, the valve core is pulled out of the valve body, and the operation is labor-saving and does not hurt hands.

### BRIEF DESCRIPTION OF FIGURES

The foregoing descriptions are merely an overview of the technical solutions of the present disclosure. In order to more clearly understand the technical means of the present disclosure, the present disclosure will be further described in detail below with reference to the accompanying drawings and specific embodiments.

FIG. 1 is a schematic diagram of the overall structure of a valve core removal tool in an embodiment of the present disclosure.

FIG. 2 is a cross-sectional view of a valve core removal tool according to the present disclosure.

FIG. 3 is a bottom view of a valve core removal tool according to the present disclosure.

FIG. 4 is a state diagram of a valve core removal tool according to the present disclosure with a valve core being locked.

FIG. 5 is a state diagram of a valve core removal tool according to the present disclosure with a valve core being removed.

Description of reference numerals:

1 denotes a sleeve; 11 denotes a fixing portion; 12 denotes sliding grooves; 13 denotes a mounting hole; 14 denotes a second clamp ring; 15 denotes a thrust bearing;

2 denotes an inner cylinder; 21 denotes a first clamp ring;

3 denotes locking portions; 31 denotes jack screw holders; 311 denotes through holes; 32 denotes jack screws; 33 denotes handles;

4 denotes a screw rod; 41 denotes a screw cap;

5 denotes a rotary cap; 51 denotes a shaft sleeve; and 52 denotes a groove.

### DETAILED DESCRIPTION

The technical solutions of the present disclosure will be clearly and completely described below in conjunction with the accompanying drawings.

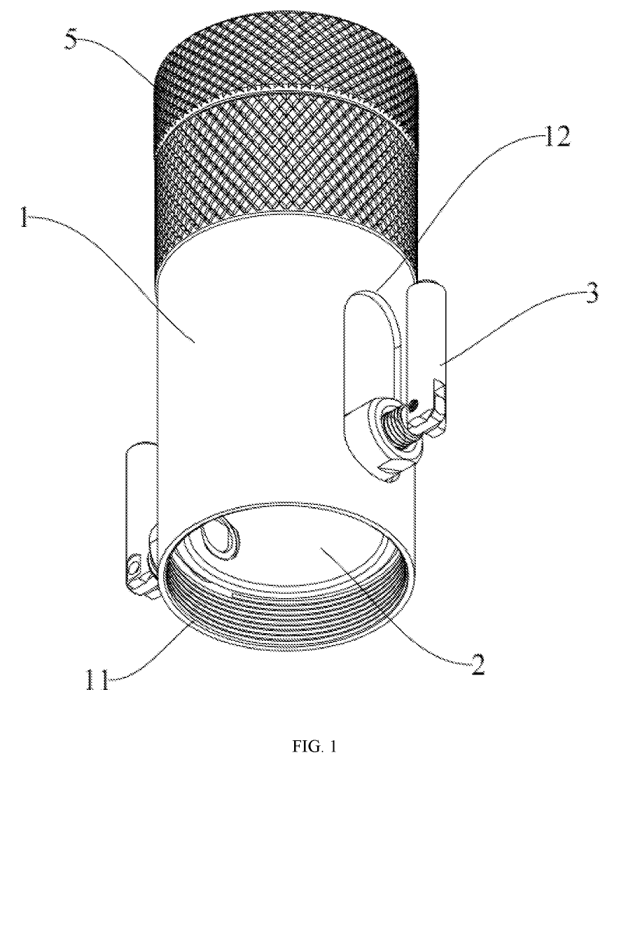

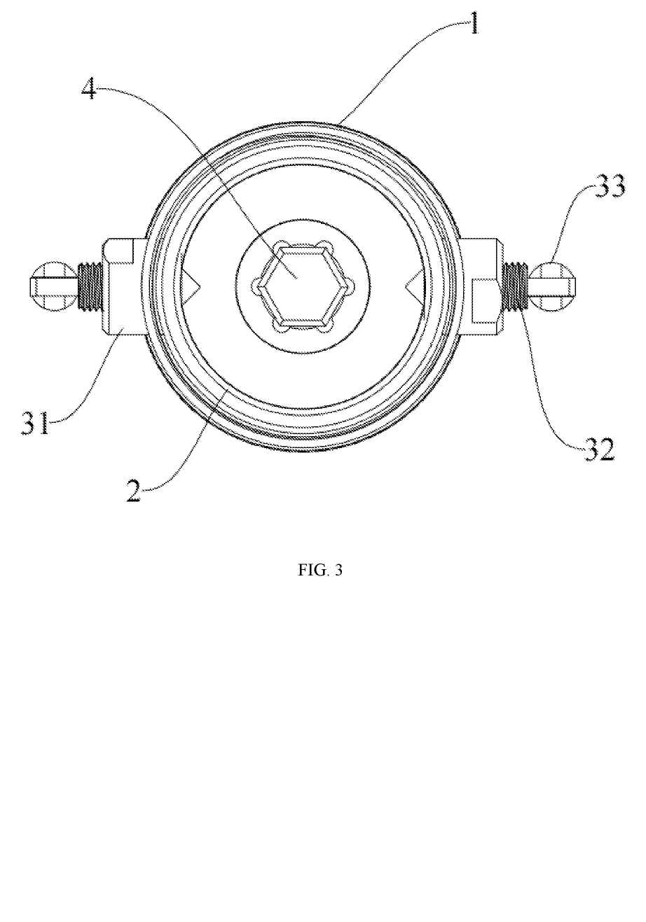

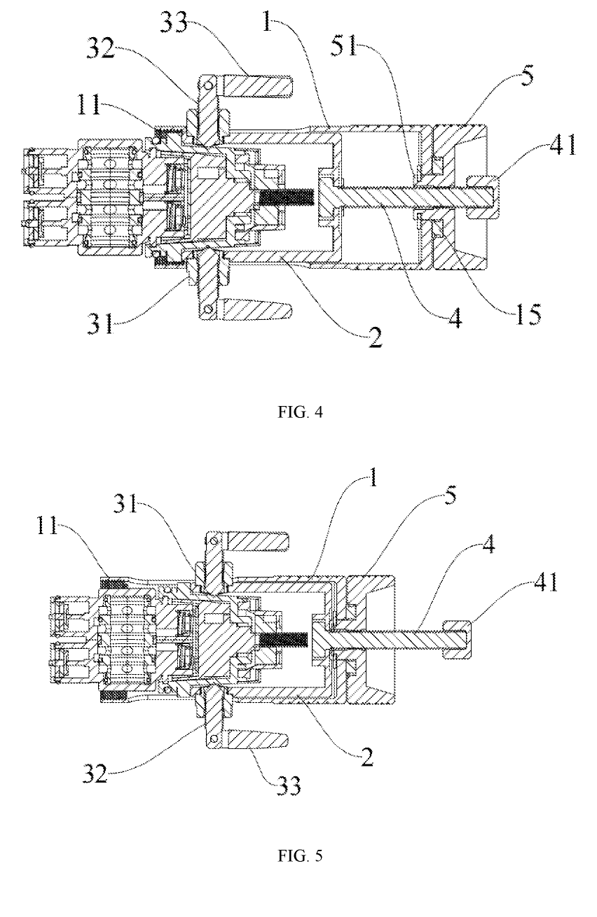

Please refer to a specific embodiment of a valve core removal tool as shown in FIG. 1 to FIG. 5. When the tool is used for removing, a faulty valve core can be easily removed without using additional tools such as pliers, and the problem of the plastic valve core being broken and stuck inside the valve body will not occur during the removing process. The valve core removal tool solves the current problem that a valve core is mainly taken out by clamping with locking pliers and then pulling with manpower or by tapping with an external force, which takes too long to extract the valve core, so that the production is affected, and the labor intensity of workers is increased.

As shown in FIG. 1 to FIG. 3, in this embodiment, the valve core removal tool includes a sleeve 1 with a bottom opening; an inner cylinder 2 with a bottom opening sleeved inside the sleeve 1, moving along an axial direction of the sleeve 1; locking portions 3, provided on both sides of the inner cylinder 2 and moving along a radial direction of the inner cylinder 2; and a screw rod 4, axially arranged on the inner cylinder 2, with one end connected to the inner cylinder 2 and the other end extending out of the sleeve 1, where a fixing portion 11 is provided at the bottom opening of the sleeve 1, the inner cylinder 2 is moved above the fixing portion 11, the locking portions 3 move inward for locking, the screw rod 4 rises along the sleeve 1, and the inner cylinder 2 moves upward along the axial direction of the sleeve 1 away from a bottom of the sleeve 1 based on the movement of the screw rod 4. The inner cylinder 2 slidable up and down is arranged inside the sleeve 1, the valve core is fixed by the locking portions 3 provided on both sides of the inner cylinder 2, the screw rod 4 is arranged on a top of the inner cylinder 2, the bottom of the sleeve 1 is fixed with the valve body, the screw rod 4 rises and drives the inner cylinder 2 to move upward, and the valve core is easily pulled out of the valve body. The faulty valve core can be easily removed without using any additional tools in the removing process.

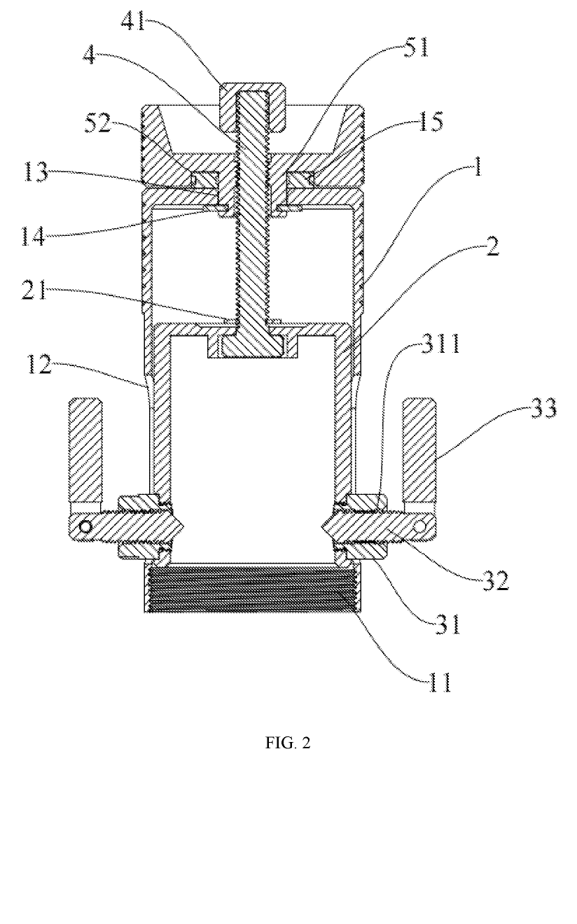

Specifically, as shown in FIG. 1 and FIG. 2, sliding grooves 12 are provided on both sides of the sleeve 1, the locking portions 3 extend out of the sleeve 1 through the sliding grooves 12, and the locking portions 3 slide in the sliding grooves 12 with the movement of the inner cylinder 2. The locking portions 3 are symmetrically arranged on an outer circumferential wall of the inner cylinder 2, and move up and down with the inner cylinder 2. The symmetrical sliding grooves 12 are formed in an outer circumferential wall of the sleeve 1, and the locking portions 3 fixedly mounted on the inner cylinder 2 extends out of the sleeve 1 through the sliding grooves 12. The locking portions 3 slide in the sliding grooves 12 to limit the inner cylinder 2, so that the inner cylinder 2 is enabled to slide up and down in a straight line in the sleeve 1. The sliding grooves 12 are provided above the fixing portion 11 located at the bottom of the sleeve 1, so that the inner cylinder 2 is enabled to slide within the sleeve 1, without sliding outside the sleeve 1. When in use, the inner cylinder 2 needs to be slid to an initial position, and the initial position of the inner cylinder 2 is close to the bottom of the sleeve 1, which is a fixed distance reserved for connecting the fixing portion 11 with the valve body. An inner wall of the fixed portion 11 is designed with an internal thread structure for threaded connection and fixation with the valve body.

Specifically, as shown in FIG. 1 and FIG. 2, the locking portions 3 include jack screw holders 31 arranged on both sides of the inner cylinder 2, jack screws 32 matched with the jack screw holders 31, and a handle 33 mounted on one end of each of the jack screws 32. The jack screw holders 31 are provided with through holes 311 with internal threads, and the through holes 311 are communicated with the inner cylinder 2. By rotating the jack screws 32 with the handles 33, the jack screws 32 move inward through the through holes 311 for locking and fixing. A tapered spike structure is provided on a head of each of the jack screws 32. When in use, the jack screws 32 are unscrewed by the handles 33 to lower the inner cylinder 2 to the initial position, the fixing portion 11 at the bottom of the sleeve 1 is connected to the target valve body by threads, and after connection, the handles 33 are rotated to screw in the jack screws 32. The jack screws 32 are in threaded connection with the jack screw holders 31, so that the jack screws 32 are enabled to pierce into a plastic case outside the valve core to achieve locking with the valve core.

It can be understood that each of the external structures of the sleeve 1 and the inner cylinder 2 in this embodiment is a cylindrical structure with an opening at one end, and apertures of the sleeve 1 and the inner cylinder 2 can be adjusted according to models of the valve body and the valve core. In this embodiment, two sliding grooves 12 and two locking portions 3 are provided, which are symmetrically arranged on the sleeve 1 and the inner cylinder 2, respectively. The number of the sliding grooves 12 and the number of the locking portions 3 are not specifically defined. After the jack screws 32 are mounted into the jack screw holders 31, there is a limit for both screwing and unscrewing of the jack screws.

Preferably, as shown in FIG. 1 to FIG. 5, a first clamp ring 21 is arranged outside the top of the inner cylinder 2, and the screw rod 4 is fixed on the inner cylinder 2 by the first clamp ring 21. The tool further includes a rotary cap 5 fitted to a top of the sleeve 1, and a shaft sleeve 51 is arranged at a bottom center of the rotary cap 5 in a protruding manner. A mounting hole 13 is reserved in a top center of the sleeve 1, and the shaft sleeve 51 extends into the sleeve 1 through the mounting hole 13. A second clamp ring 14 is arranged inside the top of the sleeve 1, and is clamped with the shaft sleeve 51. The rotary cap 5 is rotatably fixed on the sleeve 1 by the shaft sleeve 51 and the second clamp ring 14. The rotary cap 5 is rotatably arranged on the sleeve 1, the screw rod 4 is fixedly connected to the inner cylinder 2, and the rotary cap 5 is rotated to make the screw rod 4 move up and down and then drive the inner cylinder 2 to move up and down. The fixing portion 11 at the bottom of the sleeve 1 is fixedly connected with the target valve body. The handles 33 are rotated to screw in the jack screws 32. The jack screws 32 are in threaded connection with the jack screw holders 31, so that the jack screws 32 are enabled to pierce inward into the plastic case outside the valve core to achieve locking with the valve core. The inner cylinder 2 moves upward to lift the valve core out of the valve body.

It should be noted that the first clamp ring 21 and the second clamp ring 14 are designed as E-shaped clamp rings, the inner cylinder 2 and the screw rod 4 are clamped by the E-shaped clamp rings and do not slide freely, and the rotary cap 5 is rotatably connected to the sleeve 1 by the E-shaped clamp rings.

Specifically, the shaft sleeve 51 is internally provided with a threaded structure, the screw rod 4 is connected to the shaft sleeve 51 in cooperation, the rotary cap 5 rotates on the top of the sleeve 1 to drive the screw rod 4 to move upward, and the inner cylinder 2 is driven by the screw rod 4 to slide upward. A thrust bearing 15 is mounted on the top of the sleeve 1, a groove 52 is formed in a bottom of the rotary cap 5, and the groove 52 is in nested fit with the thrust bearing 15. Threads in the shaft sleeve 51 are in threaded connection with the screw rod 4, and the screw rod 4 is driven to go up and down by rotating the rotary cap 5. When the screw rod 4 moves upward, the inner cylinder 2 slides upward with the screw rod 4. The thrust bearing 15 is fixed on the top of the sleeve 1, the thrust bearing 15 is embedded into the groove 52 formed in the bottom of the rotary cap 5, and the rotary cap 5 is fixed on the sleeve 1 for rotation. The thrust bearing 15 bears part of the upward pulling force, and strengthens the structural strength.

Preferably, as shown in FIG. 1 to FIG. 5, a screw cap 41 is arranged at the end of the screw rod 4 extending out of the sleeve 1, which facilitates disassembly, installation, and replacement of parts.

In the description of the present disclosure, it should be understood that, the orientation or positional relationship indicated by the term "upper", "lower", "front", "rear" or the like is based on the orientation or positional relationship shown in the accompanying drawings. This is only for the convenience of describing the present disclosure and simplifying the description, and does not indicate or imply that a device or element must have a specific orientation, or be constructed and operated in a specific orientation, and therefore cannot be understood as a limitation of the present disclosure.

In the description of this application, it should be noted that unless otherwise explicitly specified or defined, the terms such as "mount", "connect", and "connection" should be understood in a broad sense. For example, the connection may be a fixed connection, a detachable connection, or an integral connection; or the connection may be a mechanical connection or an electrical connection; or the connection may be a direct connection, an indirect connection through an intermediary, or internal communication between two components. For those of ordinary skill in the art, the specific meanings of the aforementioned terms in the present disclosure can be understood according to specific conditions.

The foregoing descriptions are merely exemplary embodiments of the present disclosure, and are not intended to limit the present disclosure in any form. Some simple amendments, equivalent changes or modifications made by those skilled in the art based on the technical contents disclosed above shall fall within the protection scope of the present disclosure.

What is claimed is:

1. A valve core removal tool, comprising:
a sleeve with a bottom opening;
an inner cylinder with a bottom opening sleeved inside the sleeve, moving along an axial direction of the sleeve;
locking portions, provided on both sides of the inner cylinder and moving along a radial direction of the inner cylinder; and
a screw rod, axially arranged on the inner cylinder, with one end connected to the inner cylinder and the other end extending out of the sleeve, wherein
a fixing portion is provided at the bottom opening of the sleeve, the inner cylinder is moved above the fixing portion, the locking portions move inward for locking, the screw rod rises along the sleeve, and the inner cylinder moves upward along the axial direction of the sleeve away from a bottom of the sleeve based on the movement of the screw rod.

2. The valve core removal tool according to claim 1, wherein sliding grooves are provided on both sides of the sleeve, the locking portions extend out of the sleeve through the sliding grooves, and the locking portions slide in the sliding grooves with the movement of the inner cylinder.

3. The valve core removal tool according to claim 2, wherein the locking portions comprise:
jack screw holders arranged on both sides of the inner cylinder, jack screws matched with the jack screw holders, and a handle mounted on one end of each of the jack screws;
the jack screw holders are provided with through holes with internal threads, and the through holes are communicated with the inner cylinder; and by rotating the jack screws with the handles, the jack screws move inward through the through holes for locking and fixing.

4. The valve core removal tool according to claim 3, wherein a tapered spike structure is provided on a head of each of the jack screws.

5. The valve core removal tool according to claim 1, further comprising a rotary cap fitted to a top of the sleeve, a shaft sleeve being arranged at a bottom center of the rotary cap in a protruding manner, wherein
a mounting hole is reserved in a top center of the sleeve, and the shaft sleeve extends into the sleeve through the mounting hole;
a second clamp ring is arranged inside the top of the sleeve, and is clamped with the shaft sleeve; the rotary cap is rotatably fixed on the sleeve by the shaft sleeve and the second clamp ring; and
the shaft sleeve is internally provided with a threaded structure, the screw rod is connected to the shaft sleeve in cooperation, the rotary cap rotates on the top of the sleeve to drive the screw rod to move upward, and the inner cylinder is driven by the screw rod to slide upward.

6. The valve core removal tool according to claim 5, wherein a thrust bearing is mounted on the top of the sleeve, a groove is formed in a bottom of the rotary cap, and the groove is in nested fit with the thrust bearing.

7. The valve core removal tool according to claim 1, wherein the fixing portion has an internal thread structure.

8. The valve core removal tool according to claim 5, wherein a first clamp ring is arranged outside a top of the inner cylinder, and the screw rod is fixed on the inner cylinder by the first clamp ring.

9. The valve core removal tool according to claim 8, wherein the first clamp ring and the second clamp ring are designed as E-shaped clamp rings.

10. The valve core removal tool according to claim 1, wherein a screw cap is arranged at the end of the screw rod extending out of the sleeve.
